(19) United States
(12) Patent Application Publication
(10) Pub. No.: US 2015/0229766 A1
(43) Pub. Date: Aug. 13, 2015

(54) Methods and Systems for Routing Emergency Service Calls Background

(71) Applicant: Synergem Technologies, Inc., Greensboro, NC (US)

(72) Inventors: Myron S. Herron, JR., Greensboro, NC (US); C.A. Patrick Voigt, Greensboro, NC (US)

(73) Assignee: Synergem Technologies, Inc., Greensboro, NC (US)

(21) Appl. No.: 14/180,310

(22) Filed: Feb. 13, 2014

(51) Int. Cl. H04M 3/51

(52) U.S. Cl. CPC H04M 3/5116

(57) ABSTRACT

Methods and systems for routing an emergency services call across an emergency services network to a public safety answering point (PSAP) in accordance with the NG9-1-1 standard are disclosed herein. Generally, a communication session is established between an originating network provider and a conference bridge on the emergency services network. A preferred destination PSAP is then determined and a second communication session is established between the conference bridge and the destination PSAP.

### BACKGROUND

Recent advances in communication technology, specifically data connectivity and voice-over-IP technology (described below), have led to the implementation of the Next Generation 9-1-1 standard by the National Emergency Number Association (NENA). Broadly speaking, Next Generation 9-1-1 (“NG9-1-1”) can be viewed as a system comprised of Emergency Services IP networks (“ESInets”), internet protocol (“IP”) based software services and application, and various databases and data management processes that are all interconnected to a public safety answering point (PSAP). The NG9-1-1 system provides location-based routing to the appropriate emergency entity, such that a caller in need of help is automatically routed to the PSAP assigned to the caller's location. NG9-1-1 also provides standardized interfaces for call and message services, processes all types of emergency calls including non-voice (multi-media) messages, acquires and integrates additional data useful to call routing and handling for appropriate emergency entities. NG9-1-1 supports all legacy E9-1-1 features and functions and is intended to provide scalable solution for meeting current and emerging needs for emergency communication between callers and Public Safety entities.

The NG9-1-1 system architecture is currently defined by the NENA “i3” standard and is described in detail in the “Detailed Functional and Interface Specification for the NENA i3 Solution—Stage 3” (NENA 08-003 v1, Jun. 14, 2011), the entirety of which is incorporated herein by reference, as are all publically available documents and publications referenced therein.

The NG9-1-1 standard supports end-to-end IP connectivity between a caller and a public safety answering point (PSAP). A PSAP is a call center responsible for answering calls to an emergency telephone number for police, firefighting, and ambulance services (9-1-1 throughout the United States). Trained emergency service call takers are typically responsible for obtaining relevant information from a caller and dispatching the appropriate emergency service resources to the appropriate location. The NG9-1-1 standard defines an ESInet, which sits between various, non-emergency communications networks and one or more PSAPs, and also defines the the ESInet's various functional elements, such as a Border Control Function, Location Information Server, Location Validation Function, the Emergency Services Routing Proxy, Policy Routing Function, and the Emergency Call Routing Function. All of these elements are designed to provide robust and secure communications between a variety of communications devices and emergency service providers.

The NG9-1-1 standard requires that all calls presented to the ESInet from an originating network, such as a typical telecommunications service provider (“TSP”) network, include information describing the geographical location of the origin of the call (e.g. a street address or geodetic coordinates). Upon reaching the ESInet, call traffic encounters the Border Control Function (BCF) which sits between external networks and the ESInet. An emergency service call, with location information, enters the ESInet through the BCF. After passing through the BCF, the first element inside the ESInet is the Emergency Services Routing Proxy (ESRP). The ESRP receives the call, and passes this information to an Emergency Call Routing Function (ECRF), which determines the next hop in routing a call to the requested service. The ECRF maps the call's location information and requested service (e.g. police, which may be routed to a city-operated PSAP or fire department, which may be routed to a county-operated PSAP) to an appropriate PSAP.

FIG. 1 depicts a previously known communications system 100, including originating network provider 102 and an NG9-1-1 compliant ESInet 108 capable of being in data communication with the originating network provider via a communication session corresponding an emergency services call via an SIP/RTP communication session 112 The ESInet 108 is also in data communication with one or more PSAPs, such as NG9-1-1 compliant PSAP 120 and legacy PSAP 124, via communication sessions 125, 126 corresponding to emergency services calls being received from originating network provider 102, e.g. via an SIP/RTP communication session. The ESInet 108 includes NG9-1-1 functional elements, such as an ESRP module and ECRF module which collectively determine which PSAP the incoming call should be routed to. The incoming emergency services call audio, in the form of RTP, is connected to the BCF module via the RTP communication session 112 and, once the routing determination is made, an additional RTP communication session 125 is established between the BCF module and the designated PSAP. The caller is now connected to a call taker at the designated PSAP.

In the conventional system shown in FIG. 1, in the event an in-progress emergency services call has to be transferred to an alternative PSAP, such as NG9-1-1 compliant PSAP 120, or some other entity, either the connection 125 to the existing PSAP must be terminated at the ESInet and a new connection 126 established with the new PSAP, or the existing PSAP 124 must initiate a new SIP/RTP session 130 with the new PSAP 120. The former case is disfavored because it is considered unadvisable to disconnect an in progress 9-1-1 call. The latter case is disfavored because it is bandwidth intensive.

Advantageously, the present methods and systems permit a call to be connected to multiple PSAPs or other emergency service resources without disconnecting the call from any other party. Further, the present methods and systems anchor the call at a central conference bridge, reducing the bandwidth load on the overall network. The methods and systems described and claimed below are intended to address these and other deficiencies in the art. These methods and systems may utilize known technologies, methods, standards, and/or techniques combined and utilized in a novel and nonobvious manner in order to achieve advantages not previously appreciated by those skilled in the art. In addition to the NG9-1-1 technologies and standards described above, such known technologies, methods, standards and/or techniques may include, but are not limited to:

Internet Protocol (IP) Telephony and Voice over Internet Protocol (VoIP). IP telephony involves the application of digital networking technologies to create, transmit, and receive telecommunications sessions over computer networks. VoIP describes a methodology and group of technologies for the delivery of voice communications and multimedia sessions over IP networks, such as the Internet. The capabilities of the NG9-1-1 standard depend fundamentally on VoIP methods and technologies. Other terms commonly associated with VoIP are IP telephony, Internet telephony, voice over broadband (VoBB), broadband telephony, IP communications, and broadband phone service.

The term Internet telephony specifically refers to the provisioning of communications services (voice, fax, SMS, voice-messaging) over the public Internet, rather than via the public switched telephone network (PSTN). The steps and principles involved in originating VoIP telephone calls are similar to traditional digital telephony, and involve signaling, channel setup, digitization of the analog voice signals, and encoding. Instead of being transmitted over a circuit-switched network, however, the digital information is packetized and transmission occurs as Internet Protocol (IP) packets over a packet-switched network. Such transmission entails careful considerations about resource management different from time-division multiplexing (TDM) networks.

VoIP systems employ session control and signaling protocols to control the signaling, set-up, and tear-down of calls. They transport audio streams over IP networks using special media delivery protocols that encode voice, audio, video with audio codecs and video codecs as Digital audio by streaming media.

Session Initiation Protocol (SIP) and Real-Time Transport Protocol (RTP). SIP is a communications signaling protocol, widely used for controlling multimedia communication sessions such as voice and video calls over Internet Protocol (IP) networks.

The protocol defines the messages that are sent between peers which govern establishment, termination and other essential elements of a call. SIP can be used for creating, modifying and terminating sessions consisting of one or several media streams. Other SIP applications include video conferencing, streaming multimedia distribution, instant messaging, and file transfer. SIP works in conjunction with several other application layer protocols that identify and carry the session media. For the transmission of media streams (voice, video) SIP typically employs the Real-time Transport Protocol (RTP). RTP defines a standardized packet format for delivering audio and video over IP networks and is used extensively in communication and entertainment systems that involve streaming media, such as telephony, and video teleconference applications.

Prior to the development of modern VoIP technology, other technologies were used to allow the deaf and hard of hearing to communicate with analog-based telephone services. A teletypewriter (TTY) is such a telecommunications device for the deaf. To use a TTY, a user would, for example, set a conventional analog telephone handset onto special acoustic cups built into the TTY. The user may then type a message on the TTY's keyboard. The message is converted to a series of Baudot tones which are transmitted over the phone line. The devices described here were developed for use on the analog PSTN and are not optimized for use over digital IP networks. Thus as society increasingly moves toward IP based telecommunication, TTYs will become increasingly uncommon. However, NG9-1-1 based emergency service providers must still be able to interact with callers who may be using such devices.

Conference Bridge. One skilled in the art will further appreciate that, unlike a typical telephone call, which can generally be thought of as an end to end connection between two parties, a “conference call” is a telephone call in which two or more parties are connected to a central hub, referred to as a “conference bridge.”. A conference bridge allows for all parties to exchange information by mixing input streams (e.g., received from the participants) and generating one or more output streams (e.g., to be provided to the participants). For example, the conference bridge may combine the input audio streams to generate a summed output audio stream.

In addition to simply combining the input streams, a conference bridge can provide a number of other features for a conference call. For example, a conference bridge may analyze input audio streams to identify participants who are currently speaking (e.g., and reduce background noise by only combining input streams received from those participants). A conference bridge is typically designed to provide these, and other, functions by implementing tightly coupled modules of Digital Signal Processing (DSP) code to perform the algorithms associated with the desired functions.

### BRIEF DESCRIPTION OF THE DRAWINGS

Various embodiments in accordance with the present disclosure will be described with reference to the drawings, in which:

FIG. 1 is a functional block diagram depicting aspects of a known emergency services communications network suitable for routing emergency service calls from an originating network provider, over an NG9-1-1 complaint ESInet, to a PSAP;

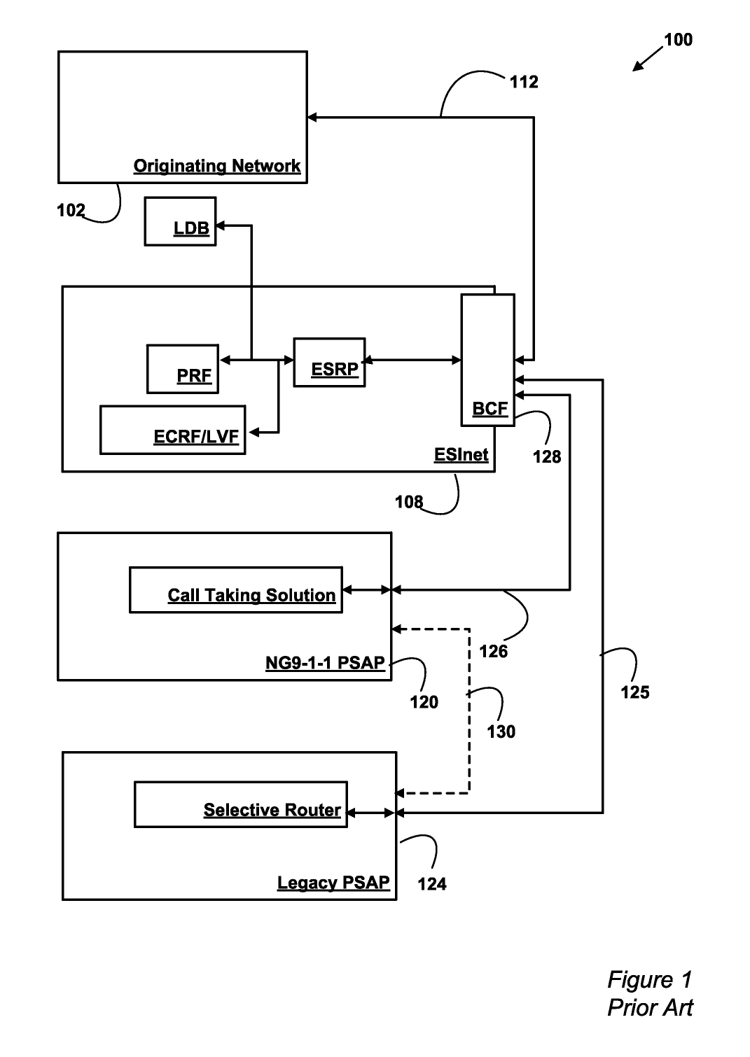

FIG. 2 is a schematic diagram depicting aspects of a non-limiting, exemplary emergency services communications network suitable for implementing at least some aspects and/or embodiments of the present systems and methods for routing emergency service calls from one or more originating network providers, over an NG9-1-1 compliant ESInet, to one or more PSAPs;

FIG. 3 is a ladder diagram depicting aspects of the communications structure between various components of the exemplary emergency services communications network shown in FIG. 2; and

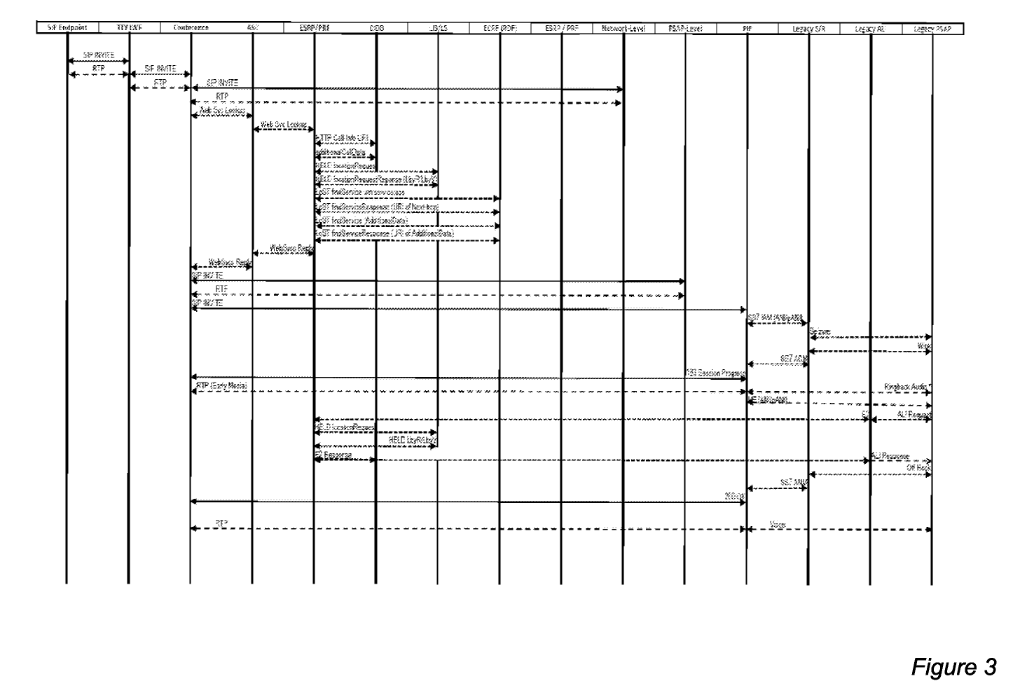

FIG. 4 is a schematic diagram depicting aspects of a non-limiting, exemplary computing architecture suitable for implementing at least some aspects and/or embodiments of the present systems and methods.

### DETAILED DESCRIPTION

This description discusses various illustrative embodiments of the present methods and systems for routing an emergency service phone call from an originating network, through an emergency services network, to a PSAP (“the present methods and systems”) with reference to the accompanying drawings in order to provide a person having ordinary skill in the relevant art with a full, clear, and concise description of the subject matter defined by the claims which follow, and to enable such a person to appreciate and understand how to make and use the same. However, this description should not be read to limit the scope of the claimed subject matter, nor does the presence of an embodiment in this description imply any preference of the described embodiment over any other embodiment, unless such a preference is explicitly identified herein. It is the claims, not this description or other sections of this document or the accompanying drawings, which define the scope of the subject matter to which the inventor and/or the inventor's assignee(s) claim exclusive rights.

Embodiments of the present methods and systems may be implemented by systems using one or more programmable digital computers. Computer and computer systems in connection with embodiments of the invention may act, e.g., as workstations and/or servers, such as described below. Digital voice and/or data networks such as may be used in connection with embodiments of the invention may also include components (e.g., routers, bridges, media gateways, etc.) with similar architectures, although they may be adapted, e.g., as known in the art, for their special purposes. Because of this commonality of architecture, such network components may be considered as computer systems and/or components of computer systems when consistent with the applicable context.

Generally, in the event an originating network provider receives an emergency services phone call over its network, the originating network provider will establish a communication session with the local ESInet across a communications network, which may be a combination of public and private networks, for the purpose of transmitting data corresponding to the emergency services phone call between the originating network provider and the ESInet. Components of the ESInet then determine which PSAP should receive the incoming emergency services call, e.g. by determining the geographical location where the call is originating in accordance with defined NG9-1-1 methodologies and identifying which PSAP serves that location. The ESInet will then establish a communication session with the designated PSAP for the purpose of transmitting data corresponding to the emergency services phone call between the ESInet and the PSAP and then route data between the communication session with originating network provider and the communication session with the designated PSAP.

The present methods and systems generally describe routing an incoming emergency services call from an originating network provider, across an emergency services network, to a preferred destination PSAP. Some aspects of the described embodiments relate to methods including: establishing a first communication session in accordance with a preferred communication protocol between a source and a conference bridge, the source being a source of a conforming input data stream corresponding to the incoming emergency services call to be transmitted across the first communication session and the conference bridge being at least capable of combining a plurality of input data streams into at least one output data stream; determining a destination PSAP for the emergency services call from one or more potential PSAPs in accordance with a defined emergency service call routing standard; establishing a second communication session in accordance with the preferred communication protocol between the conference bridge and a destination; and receiving the conforming input data stream at the conference bridge via said the communication session and transmitting a conforming output data stream corresponding to the emergency services phone call to the destination via the second communication session.

Other aspects of some of the described embodiments relate to methods of routing an emergency services call across an emergency services network to a PSAP that include the steps of: establishing a first communication session between an originating network provider and a data testing module and receiving a data stream transmitted from the originating network provider via the first communication session; determining by the data testing module whether the data stream was generated at least in part in accordance with a first communication protocol, and, if so, modifying the data stream to conform to a preferred second communication protocol, the first communication protocol relating to representing human readable text via analog frequencies and the second communication protocol relating to representing human readable text via digital data strings; establishing a second communication session between said data testing module and a conference bridge, said conference bridge being capable of combining a plurality of input data streams into at least one output data stream; determining a preferred destination PSAP for said emergency services call from one or more potential destination PSAPs in accordance with an emergency service call routing standard; and establishing a second communication session between said conference bridge and said destination PSAP.

Other non-limiting aspects of described embodiments relate to a system for establishing data communication between an originating network provider and a PSAP across an emergency services network, said data communication representing an emergency services call, the system including a conference bridge module in data communication with the originating network provider, the conference bridge being capable of combining a plurality of input data streams into at least one output data stream in accordance with a first, preferred communication protocol; and at least one PSAP level recording module in data communication with the conference bridge module via the emergency services network in accordance with the first, preferred communication protocol. In such embodiments, the conference bridge module forms a first communication session with said origination network provider and a second communication session with a destination PSAP selected by the destination routing module; the plurality of input data streams to the conference bridge includes data steams received from the originating network provider via the first communication session and from the destination PSAP via the second communication session; and the at least one output data stream from the conference bridge is transmitted over the first and second communication sessions.

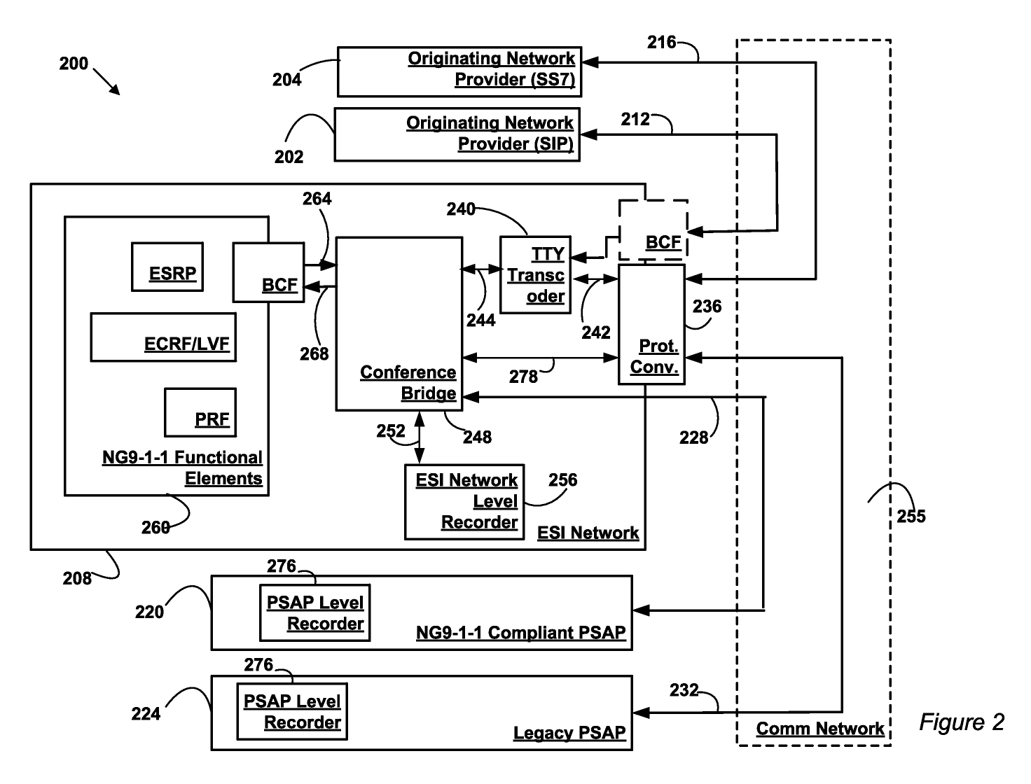

FIG. 2 depicts, by way of a non-limiting example, a communications system 200, including originating network providers 202, 204; an NG9-1-1 compliant ESInet 208 having an NG9-1-1 Functional Elements (NFE) module 260, for selecting the appropriate PSAP in accordance with the NG9-1-1 standard, and further embodying various aspects of the present methods and systems; NG9-1-1 compliant PSAP 220; and legacy PSAP 224, all interconnected via a communications network 225.

In order to demonstrate alternative but non-limiting examples of the functionality of the present methods and systems, originating network provider 202 is assumed to transmit emergency service calls via SIP/RTP communication sessions, whereas originating network provider 204 is assumed to transmits emergency service calls via an alternate communication session compliant with another communication protocol, such the SS7 signaling protocol. Similarly, PSAP 220 is assumed to conform to the NG-911 standard, which is therefore capable of establishing SIP/RTP communication sessions directly with the ESInet (e.g. 228), whereas PSAP 224 is assumed to be a legacy PSAP, which is only capable of establishing communications sessions with the ESInet that are compliant with another communication protocol, such the SS7 signaling protocol (e.g. 224) and alternative emergency service standard, such as Enhanced 9-1-1 (the predecessor to NG9-1-1).

In accordance with an embodiment of at least one aspect of the present methods and systems, ESInet 208 advantageously includes a protocol conversion module 236 for interfacing with non-SIP/RTP communication sessions (e.g. 216, 232), TTY transcoding module 240 for testing the communication sessions corresponding to all incoming emergency service calls to determine whether the incoming call is a TTY call, a conference bridge module 248 for combining the incoming data streams from the originating network provider and, once the call is connected, from the designated PSAP, into a single outgoing data stream, a network level recorder module 256 for recording all data exchanged between the originating network provider and the ESInet for a given emergency services call, and a PSAP level recorder module 276 for recording all data exchanged between the originating network provider and the designated PSAP for a given emergency services call.

Protocol conversion module 236 receives any incoming non-SIP/RTP communication sessions (e.g. 216) from non-SIP originating network provider 204, establishes corresponding SIP/RTP communication sessions (e.g. 242) with TTY transcoder module 240, and passes data between the two communication sessions 216, 242. Similarly, and explained in more detail below, if conference bridge module 248 needs to route an emergency service call to legacy PSAP 224, the conference bridge module establishes a SIP/RTP communication session 278 with protocol conversion module 236, and the protocol conversion module in turn establishes a corresponding non-SIP communication session 232 with the legacy PSAP and passes data between the two communication sessions 278, 232.

In accordance with an embodiment of another aspect of the present methods and systems, TTY transcoder module 240 determines for each emergency services call sent to ESInet 208 whether it is a TTY-based call by detecting the presence or absence of Baudot tones in the call. TTY technology has largely been supplanted by other protocols and thus, in real-world applications, it is expected that the vast majority of calls received by ESInet 208 will not be TTY calls. However, in the event a TTY call is detected, TTY transcoder 240 will transcode the Baudot tone packets to RFC4103 (the RTP Payload for Text Conversation standard) packets, in compliance with the NG9-1-1 standard. The TTY transcoder module 240 then establishes a corresponding SIP/RTP session 244 with conference bridge module 248.

In accordance with an embodiment of another aspect of the present methods and systems, conference bridge module 248 acts as a central hub for emergency service calls coming into ESInet 208. When an emergency service call is delivered to conference bridge module 248 from TTY transcoder 240 via SIP/RTP session 244, the conference bridge module establishes several additional SIP/RTP communication sessions. First, conference bridge module 248 establishes SIP/RTP communication session 252 with network level recorder 256 for recording all data passing through ESInet 208 corresponding to a particular emergency services call. Next, conference bridge module 248 interfaces with NFE module 260 in order to determine which PSAP should receive the emergency services call. Conference bridge module 248 then establishes a second SIP/RTP communication session 272 with a PSAP-level recorder 276, for recording all data being transmitted to the PSAP designated by the NFE module 260. Finally, the conference bridge module 248 establishes a third SIP/RTP communication session for connecting the emergency services call to the designated PSAP. If the designated PSAP is NG9-1-1 complaint PSAP 220, conference bridge module 248 may establish a SIP/RTP session 228 directly with the PSAP's call taking solution (not shown) to be queued and answered by a call taker (not shown). If the designated PSAP is not NG9-1-1 compliant, e.g. Legacy PSAP 224, conference bridge module 248 establishes a SIP/RTP communication session 278 with protocol conversion module 236, which then establishes the appropriate type of communication session 232 with legacy PSAP 224.

In accordance with at least one other aspect of the present methods and systems, the interface between conference bridge module 248 and NFE module 260 is advantageously not a full SIP/RTP communication session. To perform all the functionality required by the NG9-1-1 standard, the NFE module only requires metadata related to the emergency services call, which is carried by the corresponding SIP invitation (as opposed to the voice, video, and/or other data that makes up the call itself and is carried by the RTP stream). Thus, conference bridge module 248 only sends NFE module 260 the metadata necessary for the NFE module to determine which PSAP the call should be routed to, for example via SIP invitation 264. NFE module 260 determines and returns that information to the conference bridge module, for example via return SIP invitation 268. (Alternatively, the conference bridge module and the NFE module may exchange the needed information via a web-services lookup or other standard technique (not shown.)

In accordance with advantageous aspects of the present methods and systems, in the event an in-progress emergency services call has to be transferred to an alternative PSAP, or some other entity has to be added to the call, such as a call taker with specialized training related to the particular emergency, the additional party or parties can be added to the call via additional SIP/RTP connections from the conference bridge.

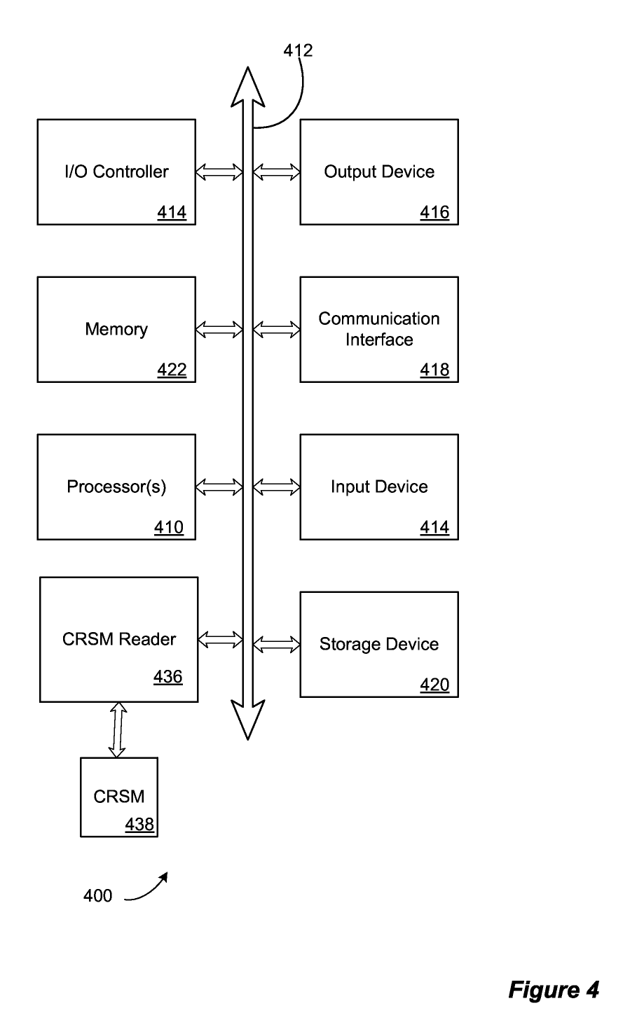

FIG. 4 depicts an example of one such computer system 400, which includes at least one processor 410, such as, e.g., an Intel or Advanced Micro Devices microprocessor, coupled to a communications channel or bus 412. The computer system 400 further includes at least one input device 414 such as, e.g., a keyboard, mouse, touch pad or screen, or other selection or pointing device, at least one output device 416 such as, e.g., an electronic display device, at least one communications interface 418, at least one data storage device 120 such as a magnetic disk or an optical disk, and memory 422 such as ROM and RAM, each coupled to the communications channel 412. The communications interface 418 may be coupled to a network (not depicted) such as the Internet.

Although the computer system 400 is shown in FIG. 4 to have only a single communications channel 412, a person skilled in the relevant arts will recognize that a computer system may have multiple channels (not depicted), including for example one or more busses, and that such channels may be interconnected, e.g., by one or more bridges. In such a configuration, components depicted in FIG. 4 as connected by a single channel 412 may interoperate, and may thereby be considered to be coupled to one another, despite being directly connected to different communications channels.

One skilled in the art will recognize that, although the data storage device 420 and memory 422 are depicted as different units, the data storage device 420 and memory 422 can be parts of the same unit or units, and that the functions of one can be shared in whole or in part by the other, e.g., as RAM disks, virtual memory, etc. It will also be appreciated that any particular computer may have multiple components of a given type, e.g., processors 410, input devices 414, communications interfaces 418, etc.

The data storage device 420 and/or memory 422 may store instructions executable by one or more processors or kinds of processors 410, data, or both. Some groups of instructions, possibly grouped with data, may make up one or more programs, which may include an operating system such as Microsoft Windows®, Linux®, Mac OS®, or Unix®. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 400 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 436, such as, e.g., a magnetic disk drive, magneto-optical drive, optical disk drive, or flash drive, may be coupled to the communications channel 412 for reading from a CRSM 438 such as, e.g., a magnetic disk, a magneto-optical disk, an optical disk, or flash RAM. Alternatively, one or more CRSM readers may be coupled to the rest of the computer system 400, e.g., through a network interface (not depicted) or a communications interface 418. In any such configuration, however, the computer system 400 may receive programs and/or data via the CRSM reader 436. Further, it will be appreciated that the term “memory” herein is intended to include various types of suitable data storage media, whether permanent or temporary, including among other things the data storage device 420, the memory 422, and the CSRM 438.

The terms “computer-readable storage medium” and “computer-readable storage media” refer, respectively, to a medium and media capable of storing information. As such, both terms exclude transient propagating signals.

Exemplary embodiments of the present methods and systems have been described in detail above and in the accompanying figures for illustrative purposes. However, the scope of the present methods and systems are defined by the claims below and is not limited to the embodiments described above or depicted in the figures. Embodiments differing from those described and shown herein, but still within the scope of the defined methods and systems are envisioned by the inventors and will be apparent to persons having ordinary skill in the relevant art in view of this specification as a whole. The inventors intend for the defined methods and systems to be practiced other than as explicitly described herein. Accordingly, the defined methods and systems encompass all modifications and equivalents of the subject matter as permitted by applicable law.

That which is claimed is:

1. A method of routing an incoming emergency services call from an originating network provider, across an emergency services network, to a preferred destination public safety answering point (PSAP) comprising the steps of:
(a) establishing a first communication session in accordance with a preferred communication protocol between a source and a conference bridge, said source being a source of a conforming input data stream corresponding to said incoming emergency services call to be transmitted across said first communication session and said conference bridge being at least capable of combining a plurality of input data streams into at least one output data stream;
(b) determining a destination PSAP for said emergency services call from one or more potential PSAPs in accordance with a defined emergency service call routing standard;
(c) establishing a second communication session in accordance with said preferred communication protocol between said conference bridge and a destination; and
(d) receiving said conforming input data stream at said conference bridge via said first communication session and transmitting a conforming output data stream corresponding to said emergency services phone call to said destination via said second, communication session.

2. The method of claim 1, wherein said preferred communication protocol is the defined Session Initiation Protocol/Real-Time Transport Protocol (SIP/RTP).

3. The method of claim 2, wherein said source is an originating network provider and said destination is said destination PSAP.

4. The method of claim 1, wherein said preferred communication protocol is the defined Session Initiation Protocol/Real-Time Transport Protocol (SIP/RTP) said source is a protocol conversion module and the method comprises, prior to step (a):
(i) establishing a third communication session in accordance with a second communication protocol between an originating network provider and said protocol conversion module; and
(ii) receiving a non-conforming data stream corresponding to said incoming emergency services call at said protocol conversion module via said third communication session.

5. The method of claim 1, wherein said preferred communication protocol is the defined Session Initiation Protocol/Real-Time Transport Protocol (SIP/RTP), said destination is a protocol conversion module and the method further comprises, subsequent to step (d):
(i) establishing a third communication session in accordance with a second communication protocol between said protocol conversion module and said destination PSAP; and
(ii) transmitting a non-conforming data stream corresponding to said incoming emergency services call to said destination PSAP via said third communication session.

6. The method of claim 1, further comprising establishing a third communication session between said conference bridge and a supplemental destination, wherein said plurality of input data streams to said conference bridge further includes data received from said supplemental destination via said third communication session and said at least one output data stream from said conference bridge is further transmitted over said fifth communication sessions.

7. The method of claim 1, wherein said input data streams and said at least one output data stream include data representing audible sounds, including human speech.

8. The method of claim 1, wherein said input data streams and said at least one output data stream include data representing video.

9. The method of claim 1, wherein said input data streams and said at least one output data stream include data representing text.

10. A method of routing an emergency services call across an emergency services network to a public safety answering point (PSAP) comprising the steps of:
(a) establishing a first communication session between an originating network provider and a data testing module and receiving a data stream transmitted from said originating network provider via said first communication session,
(b) determining by said data testing module whether said data stream was generated at least in part in accordance with a first communication protocol, and, if so, modifying said data stream to conform to a preferred second communication protocol, said first communication protocol relating to representing human readable text via analog frequencies and said second communication protocol relating to representing human readable text via digital data strings;
(c) establishing a second communication session between said data testing module and a conference bridge, said conference bridge being capable of combining a plurality of input data streams into at least one output data stream;
(d) determining a preferred destination PSAP for said emergency services call from one or more potential destination PSAPs; and
(e) establishing a second communication session between said conference bridge and said destination PSAP, and
wherein, step (d) is performed in accordance with an emergency service call routing standard.

11. A system for establishing data communication between an originating network provider and a public safety answering point (PSAP) across an emergency services network, said data communication representing an emergency services call, the system comprising:
(a) a conference bridge module in data communication with said originating network provider, said conference bridge being capable of combining a plurality of input data streams into at least one output data stream in accordance with a first, preferred communication protocol; and
(b) at least one PSAP level recording module in data communication with said conference bridge module via said emergency services network in accordance with said first, preferred communication protocol; and
wherein, (i) said conference bridge module forms a first communication session with said origination network provider and a second communication session with a destination PSAP selected by said destination routing module; (ii) said plurality of input data streams to said conference bridge includes data steams received from the originating network provider via said first communication session and from said destination PSAP via said second communication session; and (iii) said at least one output data stream from said conference bridge is transmitted over said first and second communication sessions.

12. The system of claim 11, further comprising a protocol conversion module interposed between said originating network provider and said conference bridge, wherein said protocol conversion module determines whether said originating network provider is only capable of exchanging data formatted in accordance with a communication protocol other than said first, preferred communication protocol and, if so, converting said data stream received from said originating network provider via said first communication session to conform to said preferred first communication protocol.

13. The system of claim 11, wherein said preferred first communication protocol is the standard Session Initiation Protocol/Real-Time Transport Protocol (SIP/RTP).

14. The system of claim 11, further comprising a transcoder module interposed between said originating network provider and said conference bridge, wherein said transcoder module determines a data packet contained within said data stream received from said originating network provider was in generated in accordance with a second communication protocol, and, if so, modifies said data packet to conform to a preferred third communication protocol.

16. The system of claim 15, wherein said second communication protocol is the known “Baudot tone” protocol used in TTY devices and the preferred third communication protocol is the known RTP Payload for Text Conversation protocol

17. The system of claim 11, further comprising a transcoder module interposed between said conference bridge and said destination PSAP, wherein said transcoder module determines whether said destination PSAP is incapable of exchanging data formatted in accordance with said preferred, first a communication protocol and, if so, formats said output data stream being transmitted over said second communication session in accordance with an alternate communication protocol.

18. The system of claim 11, wherein said plurality of input data streams to said conference bridge further includes a data stream received from a supplemental destination via a third communication session and said at least one output data stream from said conference bridge is further transmitted over said third communication session.

19. The system of claim 11, wherein said input data streams and at least one output data stream include data representing audible sounds, including human speech.

20. The system of claim 11, wherein said input data streams and said at least one output data stream include data representing video.

21. The system of claim 11, wherein said input data streams and said at least one output data stream include data representing text.
